(19) United States
(12) Patent Application Publication
(10) Pub. No.: US 2010/0128866 A1
(43) Pub. Date: May 27, 2010

(54) MODIFICATION OF SYSTEM CALL BEHAVIOR

(75) Inventors: Luis Irun-Briz, Bellevue, WA (US); Marcus Peinado, Bellevue, WA (US); Laurent S. Visconti, Bainbridge Island, WA (US); Nikola Livic, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/324,658

(22) Filed: Nov. 26, 2008

(51) Int. Cl. H04M 3/00

(52) U.S. Cl. 379/265.02

(57) ABSTRACT

The behavior of a system call may be modified. A modification component may pre-processes and/or post-process a system call to change the behavior of the system call. Pre-processing may involve modifying arguments to the system call, replacing one system call with another, intercepting the system call, etc. Post-processing may involve modifying results and/or side effects of a system call. The modification component may pre-process and/or post-process the system call without changes to the underlying kernel service routine that is normally invoked in response to the system call. Modifying the system call's behavior may be used to implement quality of service (QoS) constraints, to allow one operating system to emulate another, to provide information about memory layout to an application, or to serve other goals.

### BACKGROUND

Application programs use system calls to request services from an operating system (OS. The OS provides various services that are available to the application. The application uses a system call to request that the OS perform one of these services.

There may be reasons to modify a system call's behavior. However, OS services are typically implemented through service routines that are part of the OS kernel. Therefore, modification of a system call's behavior typically involves modifying the kernel code that implements a particular system call's service routine. But modifying kernel code may not be practical. Some parties who wish to modify the behavior of a system call do not have access to the kernel source code. Even if a party does have access to the kernel source code, there may be reasons not to modify the kernel code (e.g., maintaining stability of the kernel, or avoiding a departure from the OS's standard behavior).

### SUMMARY

The behavior of a system call may be modified with little or no change to the operating system kernel. A modification component may be interposed between the application that makes the system call and the service routine that acts on the system call. The modification component may perform pre- and/or post-processing on the system call. For example, the modification component could change the arguments to the system call; or could replace one system call with another; or could change the return value and/or any side effects after the system call has executed; or could respond to the system call without invoking the service routine at all.

The modification component may be added to the system-call-processing infrastructure in various ways. For example, when system calls are invoked by applications through a set of library routines, the library routines could be altered to direct the system calls to the modification component instead of to the normal system call handler. Or, as another example, tables and/or pointers that are used in routing system calls to the appropriate service routines could be changed to route a system call to the modification component. These techniques, or other techniques, could be used to route a system call to the modification component.

Modified system call behavior could be used in a variety of ways. A system call could be modified to impose quality of service (QoS) constraints—e.g., limiting a process to requesting n megabytes of memory, or writing m bytes of data per unit of time. Or, a system call could be modified to allow one operating system to emulate another operating system—e.g., modifying system calls in a MICROSOFT WINDOWS operating system kernel to behave like Linux system calls do, or vice versa. Or, as a further example, system calls could be modified to provide information that normal system calls do not provide. For example, a system call that uses or affects memory (e.g., read, write, etc.) could be modified to provide the memory layout that the kernel has assigned to a process, and/or any changes to the layout that resulted from executing the system call. (Knowledge of the memory layout could be used by a security application to detect security violations—e.g., by tracking the movement of protected data, and determining whether protected data has been moved into a memory location that is available to an untrusted process.)

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which system calls may be processed.

FIGS. 2-6 are block diagrams of various example ways in which a service modifier could be implemented and/or deployed.

FIG. 7 is a flow diagram of an example process of pre-processing a system call.

FIG. 8 is a flow diagram of an example process of post-processing a system call.

FIG. 9 is a flow diagram of an example process in which an application makes a system call that is routed to a service modifier.

FIG. 10 is a flow diagram of an example process in which one or more components to modify the behavior of a system call may be added to a computing environment, and used in that environment.

FIG. 11 is a block diagram of some example ways in which modification of system calls may be used.

FIG. 12 is a block diagram of example components that may be used in connection with implementations of the subject matter described herein.

### DETAILED DESCRIPTION

An operating system (OS) provides services that may be used by applications or other programs. Examples of services include input/output (I/O) operations (e.g., read, write, etc.), process operations (e.g., kill, fork, wait, etc.), or other kinds of operations. These services are typically exposed to the application through system calls. The system calls provide a known interface through which a program may obtain OS services. Additionally, the system calls abstract the implementation details of the service. That is, when a particular service is invoked, the service is expected to act within a defined range of behavior, but the details of how this behavior is implemented are normally opaque to the program that invokes the service.

There may be reason to change the behavior of a system call. Some example reasons to change a system call's behavior are:

To implement quality of service (QoS) constraints. For example, a system call that allocates memory to a process may have the technical capability to allocate arbitrary amounts of memory. But modified behavior of the system call might be to allocate memory while imposing, e.g., a 10 Mb per-process limit on the allocation.

To allow one OS to emulate the system calls of another OS. For example, the behavior of system calls in a MICROSOFT WINDOWS operating system kernel could be modified to behave like Linux system calls.

To provide information to applications that is not normally available through system calls. For example, system calls do not always inform an application process of the memory layout that the kernel has assigned to that process, or how I/O operations affect this layout. However, the OS has this information available, and therefore a system call could be modified to provide this information to processes (which may be useful, for example, to security applications that use knowledge of the memory layout, and of when that layout is affected, to detect and prevent security breaches). For example, any I/O operation (read, write, etc.) could causing pages to be swapped in or out of memory, which would modify the layout of memory. Another example is asynchronous I/O operations that modify the contents of memory without notifying appropriately the application. Thus, I/O system calls could be modified to report how carrying out of the system call has affected the memory mapping that the OS assigns to that process (e.g., how the system call has affected the physical location of data in the process's address space) or how this memory is being used.

The foregoing are some example reasons why one might want to modify the behavior of a system call, although the behavior of system calls could be modified for any reason.

The services that are accessed through system calls are normally implemented through service routines. Since the service routines are implemented by kernel components as part of the kernel, changing the behavior of a system call normally involves modifying the kernel code. However, modifying the kernel code may not be practical. The party who wants to modify the behavior of a system call might not have access to the kernel source code. Even if the party does have access to the source code, modifying the code of a complex OS may create stability issues. Moreover, in some cases the behavior modifications to be made are not universally-applicable. For example, one may want to modify the behavior of a system call for use in certain contexts, while having the system call behave in its normal fashion in other contexts. It may not be appropriate to modify the kernel's service routine to deal with a situation that applies only in certain contexts.

The subject matter herein may be used to modify the behavior of a system call, with little or no modification to the underlying kernel service routines through which the system call is implemented.

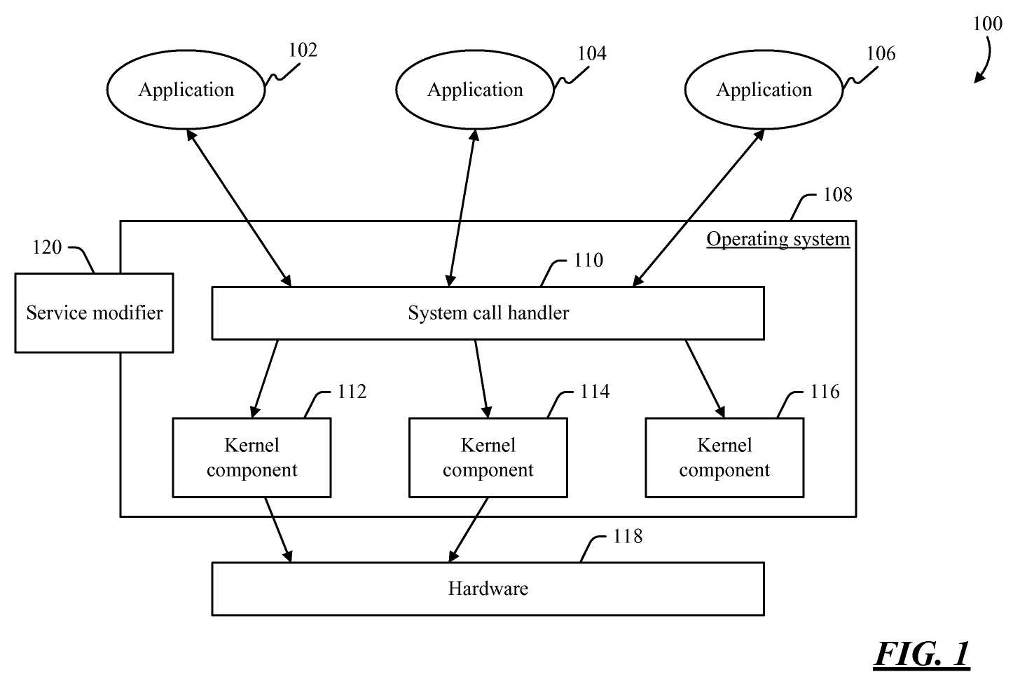

Turning now to the drawings, FIG. 1 shows an example system 100 in which system calls may be processed. Applications 102, 104, and 106 are programs that execute in an environment provided by operating system 108. Applications 102-106 may, at some point during their execution, request services from operating system 108. To allow applications 102-106 to request these services, operating system 108 provides a system call handler 110. System call handler 110 may be invoked by applications 102-106, and may, in turn, invoke the provision of services by one or more kernel components 112, 114, and 116.

Kernel components 112-116 may provide any type of service, such as I/O operations (e.g., read, write, etc.), process-related operations (e.g., wait, fork, kill, etc.), operations that control devices (e.g., turning a network card on or off), or any other type of operation. Kernel components may implement services that are native to a particular operating system, or may be add-ons, such as third-party device drivers. Some of the services provided may involve control of hardware 118 (e.g., a disk drive, a processor, physical memory, a network card, etc.) that is part of, or connected to, a machine on which operating system 108 operates. (Some services, such as killing a process, might involve tangential, although not direct, control of hardware 118.)

Kernel components 112-116 implement certain behaviors that may be invoked in response to system calls. However, these behaviors may be modified by service modifier 120. Service modifier 120 may be implemented in various ways. First, service modifier 120 may be implemented inside of operating system 108, or outside of operating system 108. (Service modifier 120 is depicted in FIG. 1 as straddling the boundary of operating system 108, indicating that it may be implemented inside operating system 108, outside of operating system 108, or partly inside and partly outside of operating system 108.) Moreover, there are various different ways in which service modifier 120 may modify the behaviors that are performed in response to system calls. In one example, service modifier 120 pre-processes and/or post-processes a system call. Pre-processing may involve modifying the application-specified parameters of a system call, and post-processing may involve modifying, or adding information to, the result produced by the system call (or removing information from that result). Another example of how service modifier 120 could modify the behaviors of system calls is to intercept the system calls without passing them to the normal service routines, so that the system calls may be serviced by other components. In general, service modifier 120 could be implemented in any manner, and could use any techniques to modify the behaviors that are performed in response to system calls. One characteristic of the service modifier may be its transparency to applications, (i.e., system calls may be intercepted, and the service modifier may be able to act, without modification to the applications that use the system calls). Another characteristic of the service modifier may be that it resists the possibility of being bypassed by the application (i.e., the service modifier may be able to apply the behavior modification even in cases where the application does not want the system call behavior to be modified).

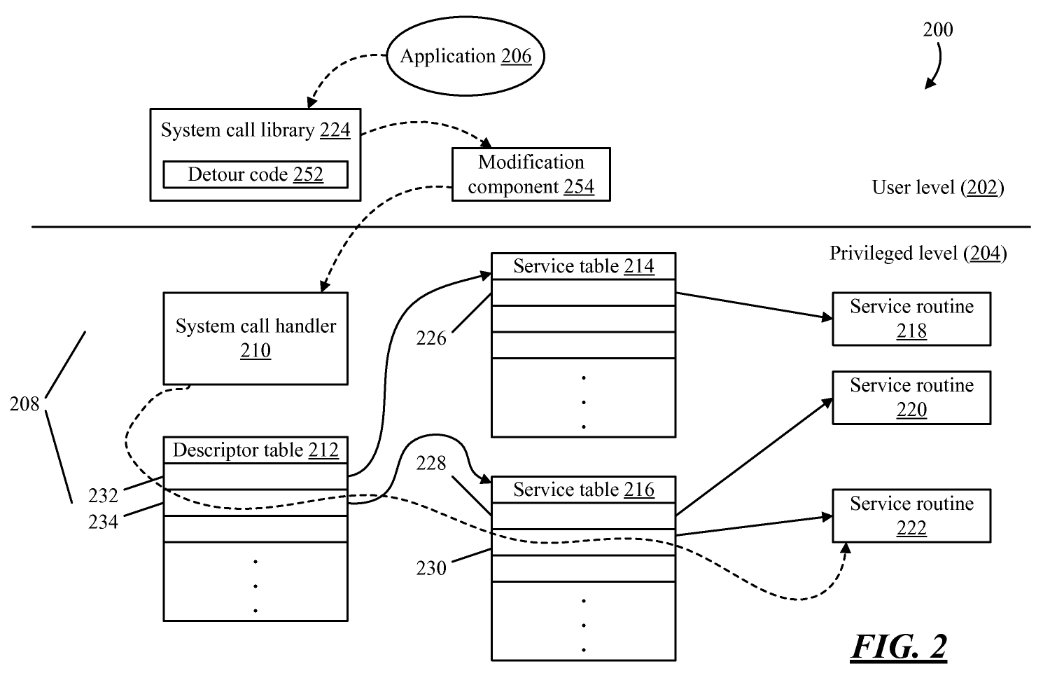

FIGS. 2-6 show various different ways in which service modifier 120 could be implemented and/or deployed.

Each of FIGS. 2-6 shows an example environment 200. Environment 200 has a user level 202 and a privileged level 204. Applications, such as application 206, execute at user level 202, and kernel 208 of operating system 108 executes at privileged level 204. (Operating system 108 is shown in FIG. 1 and is described above.)

Each of FIGS. 2-6 shows some of the components of an example kernel 208. These components may include a system call handler 210, a descriptor table 212, one or more service tables 214 and 216, and one or more service routines 218, 220, and 222. The components of kernel 208 that are shown in FIGS. 2-6 are not exhaustive. Kernel 208 may include additional components that are not shown in FIGS. 2-6, or may include fewer components than those that are shown. Additionally, while the components of kernel 208 are shown below the horizontal line indicating that they execute at privilege level 204, there may be come components that exist at privilege level 204 that are not part of kernel 208. For example, certain modification components (discussed below in connection with FIGS. 2-6) may execute at privilege level even if they are not part of kernel 208.

System call handler 210 receives a system call from some component user level 202 (e.g., from an application 206 or from another user-level program) and dispatches the call to the appropriate service routine. There are various ways in which system call handler 210 may receive the system call. In one example, an interrupt is generated at the user level, and data that identifies the service to be invoked, as well as any input to that service, is provided to the component that responds to system calls. When the interrupt is generated, system call handler is invoked and acts on the provided data. Certain hardware platforms allow system calls to be made through a sequence of instructions, which provides another way that a system call could be invoked. In order to make a system call, application 206 could generate an interrupt or could issue the appropriate instructions sequence. Application 206 could take these actions directly, or could make function calls that take the actions on behalf of application 206. For example, there may be a user modelibrary 224 (either a dynamically loaded library or a statically linked one) that provides functions corresponding to particular services and performs the appropriate system calls. Thus, if, for example, writing data to a file is a service, then library 224 may provide a function name “write”, which takes arguments (e.g., the data to be written, a descriptor of the file or device to which the data is to be written, etc.) and invokes the appropriate system call. For example, the function could generate an interrupt, or issue an appropriate instruction sequence, and could identify, to system call handler 210, the number of the service that performs the “write” operation, while also providing to system call handler 210 the arguments that were provided with the function call. The foregoing are some example ways in which system call handler 210 could be invoked, although system call handler 210 could be invoked in other ways.

When system call handler 210 is invoked, it may route the request represented by the system call to the appropriate service routine. FIGS. 2-6 show three example service routines 218-222 (although there could be any number of service routines). Service routine may be implemented by kernel components, such as one or more of the kernel components 112-116 shown in FIG. 1. Each service routine may be identified by an entry in a service table. For example, service routine 218 is identified by an entry 226 in service table 214, and service routines 220 and 222 are identified by entries 228 and 230, respectively, in service table 216. There could be a single service table, but it may be convenient for there to be separate service tables for different sets of services. For example, in certain versions of the MICROSOFT WINDOWS operating system kernel, there is a set of services known as the Win32K services, and another set of services known as the GDI32 services. Thus, service table 214 may be the table of Win32K services and service table 216 may be the table of GDI32 services. However, service routines could be grouped in any manner into any number of service tables. Each entry in a service table may be identified by an offset from the head of the table. For example, entry 226 is shown as the zero-th entry in service table 214, and entries 228 and 230 are shown as the zero-th and first entries in service table 216.

The heads of service tables 214 and 216 are identified by entries in descriptor table 212. For example entry 232 points to the head of service table 214, and entry 234 points to the head of service table 216. Thus, when system call handler 210 receives a system call, system call handler 210 determines which set of services (e.g., Win32K, GDI32, etc.) contains the service that is being invoked by the system call. System call handler 210 then looks up, in descriptor table 212, the address of the head of the service table for that service. Each service may be identified as an offset into the appropriate service table. So, if system call handler 210 determines that the service requested by a particular system call is the Win32K service whose entry has an offset of one (and if service table 216 is the service table for the Win32K services), then system call handler 210 may find the head of service table 216 by looking at entry 234 in descriptor table 212. System call handler may then find the entry 230 that is at offset one into service table 216. This entry points to service routine 222, so service routine 222 would be used to process the system call.

The following is a description of various different ways in which service modification could be implemented. These various different ways are described with reference to FIGS. 2-6. (Reference numerals 200-230 appear in each of FIGS. 2-6, and the above-description of the items associated with those reference numerals may be understood to apply to each of FIGS. 2-6.) As described above in connection with FIG. 1, a service modifier may be used to modify the behavior of a system call. A service modifier may be built using various components shown in FIGS. 2-6, such as modification components, detour code, etc.

FIG. 2 shows an example way in which a service modifier could be implemented and/or deployed. In the example of FIG. 2, application 206 makes system calls through system call library 224. System call library 224 may be modified to include detour code 252, which causes one or more of the functions in system call library 224 to invoke modification component 254. As noted above, system call library 224 may contain functions that (normally) invoke system call handler 210 in some manner (e.g., by raising interrupts, and by providing the appropriate arguments to be used by system call handler 210). These functions may be modified to include detour code 252. Thus, when these functions execute, instead of invoking system call handler 210, the functions may invoke modification component 254.

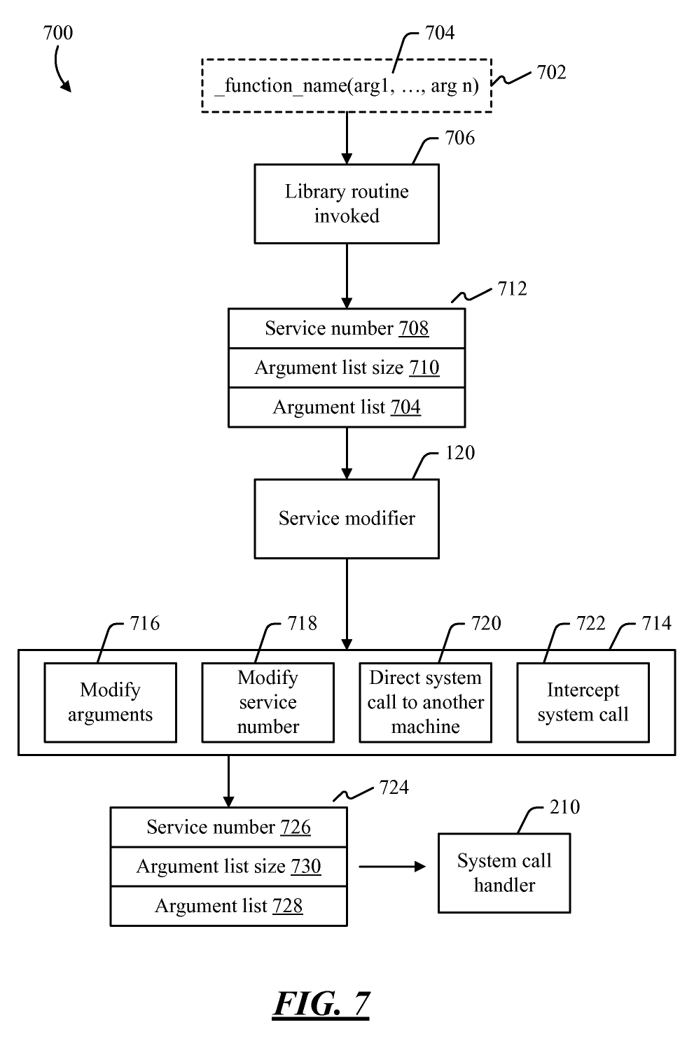

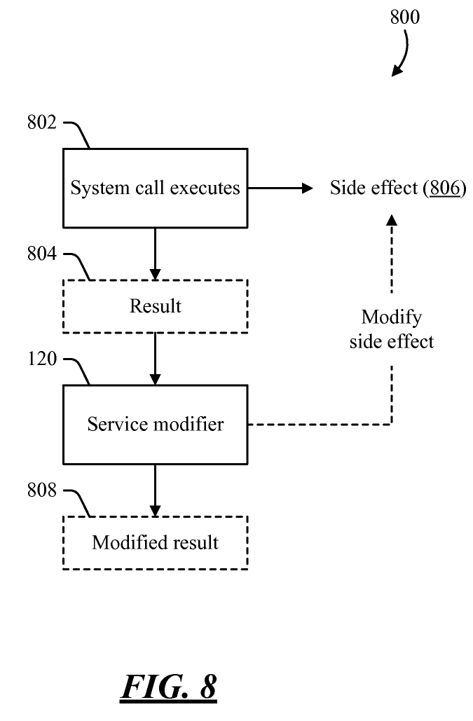

Modification component 254 may contain code that pre-processes or post-processes a system call made by application 206. Descriptions of pre- and post-processing of system calls are described below in connection with FIGS. 7 and 8. Briefly, pre-processing may involve actions such as intercepting a system call before the system call is processed by a service routine, or modifying the arguments in the system call. Post-processing may involve actions such as modifying a result returned by a service routine, changing or modifying a side effect produced by the service routine, or gathering information that would not normally be gathered in response to a system call. Actions such as these may be performed by modification component 254.

When modification component 254 is used, the path that a system call takes is shown by the dotted line in FIG. 2. In this path, application 206 makes a system call through system call library 224. Since the functions in system call library 224 execute detour code 252, this detour code routes the system call to modification component 254. Modification component 254 pre-processes the system call. If the system call is not intercepted outright by modification component 254, modification component 254 invokes system call handler 210 to handle the system call (as modified by any pre-processing that modification component 254 may have performed). System call handler 210 then looks up the appropriate service table in descriptor table 212. In the example of FIG. 2, descriptor table 212 points to service table 216. System call handler 210 then looks up the appropriate service routine in service table 216, which points to service routine 222. The system call (again, as possibly modified by any pre-processing that modification component 254 may have performed), is then routed to service routine 222. Service routine 222 may generate a result, and may also produce some side effects. For example, a “write” system call may write specified data to a particular file or device (the “side effect,” in this example), and may then return a value (e.g., true or false) indicating whether the write was successful (the “result,” in this example). Both the result and the side effects may be post-processed (e.g., modified). After service routine 222 has acted, and, optionally, after the results and side effects have been post-processed, application 206 regains control from the system call and may continue to execute.

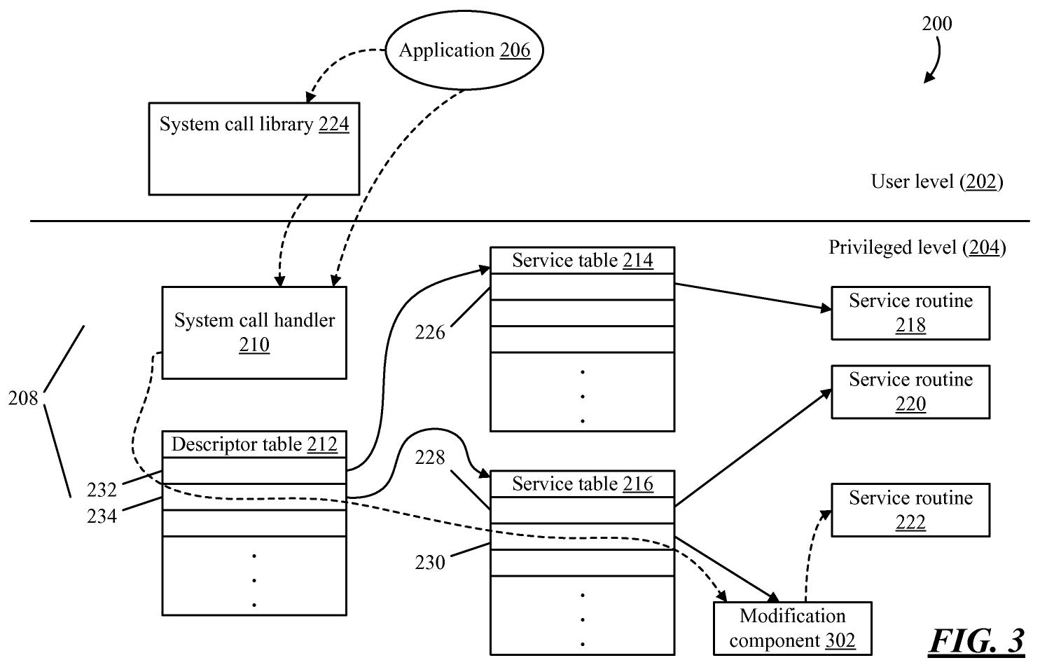

The example of FIG. 2 provides a simple way to implement service modification, since it can be implemented by adding and/or modifying user-level code in the system call library. While this implementation is viable, it has the drawback that it relies on application 206's making system calls through an appropriate library. Application 206, however, could make system calls without using the library, such as by generating interrupts to the system call handler 210 and identifying the number of the OS service to be invoked. FIGS. 3-6, however, show example implementations that do not rely on application 206's making system calls through a particular user-level library. (Thus, the dotted lines in FIGS. 3-6 show examples in which application 206 makes a system call with or without system call library 224.)

FIG. 3 shows an example way in which a service modifier could be implemented and/or deployed. In the example of FIG. 3, service modification is performed through a modification component 302 that executes at privileged level 204. Modification component 302 may be inserted into the process of handling system calls by modifying service table 216 to point to modification component 302. Thus, whereas in FIG. 2 entry 230 points to service routine 222, in the example of FIG. 3 entry 230 has been modified to point to modification component 302. An example path that a system call may take is shown by the dotted lines. Thus, when a system call is made to request a particular service, the service request is routed using descriptor table 212 and service table 216, in a manner similar to that described above in connection with FIG. 2. However, entry 230 in service table 216, instead of pointing to service routine 222 as in FIG. 2, points to modification component 302. Modification component 302 may pre-process the request represented by the system call—e.g., by modifying arguments, or by intercepting the system call. If the request is not intercepted, it is passed to service routine 222 (possibly in a form modified by modification component 302). Service routine 222 may then act on the request. If service routine generates side effects and/or results, these may be post-processed by modification component. Kernel 208 may then return control to application 206.

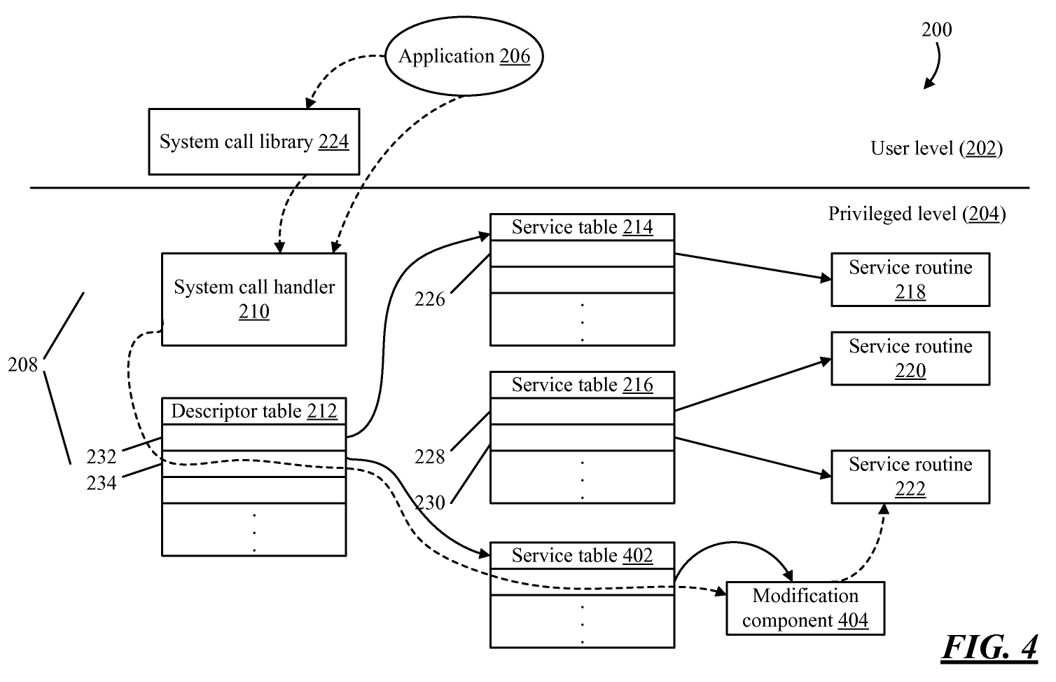

Implementation of the scenario shown in FIG. 3 involves replacing an entry in the service table to point to modification component 302 in place of a service routine. However, some operating systems do not permit modification of their native service tables. Thus, another possible implementation is shown in FIG. 4.

In FIG. 4, instead of modifying an existing service table, a new service table 402 is added. (Service tables 214 and 216 may be viewed as being native to the operating system of which they are a part. However, the new service table 402 may be viewed as not being native to the operating system.) Descriptor table 212 may be modified so that entry 234 points to service table 402 instead of service table 216. Entry 234 points to modification component 404. Modification component 404 performs pre-processing and/or post-processing of a system call. The dotted line shows example paths that a system call may take through the scenario shown in FIG. 4. According to that dotted line, application 206 first issues a system call. The system call is then received by system call handler, which looks up the appropriate service table in descriptor table 212. Because descriptor table 212 has been modified to point to service table 402 instead of service table 216, the call is routed to service table 402. The entry at the appropriate offset into service table 402 points to modification component 404, when then pre-processes the system call, before invoking service routine 222 to handle the system call. Modification component 404 may also post-process a result and/or a side effect generated by service routine 222, before returning from the system call.

The implementation of FIG. 4 shows a workaround to the problem of modifying a service table. However, some operating systems guard against modification of descriptor tables. For example, an operating system may maintain hidden shadow copies of the descriptor table, and—in processing a system call—may only follow the pointer contained in an entry in the descriptor table if that entry matches its corresponding entry in the various shadow copies. Some parties who may want to modify the behavior of a system call may not have knowledge of where the shadow copies are stored, or of how to synchronize these copies with the main copy of the descriptor table. (Since maintaining shadow copies of the descriptor table is a security technique that is used to guard against unauthorized modification of the descriptor table, knowledge of how to modify the descriptor table might be withheld from some parties who might want to modify the behavior of a system call.)

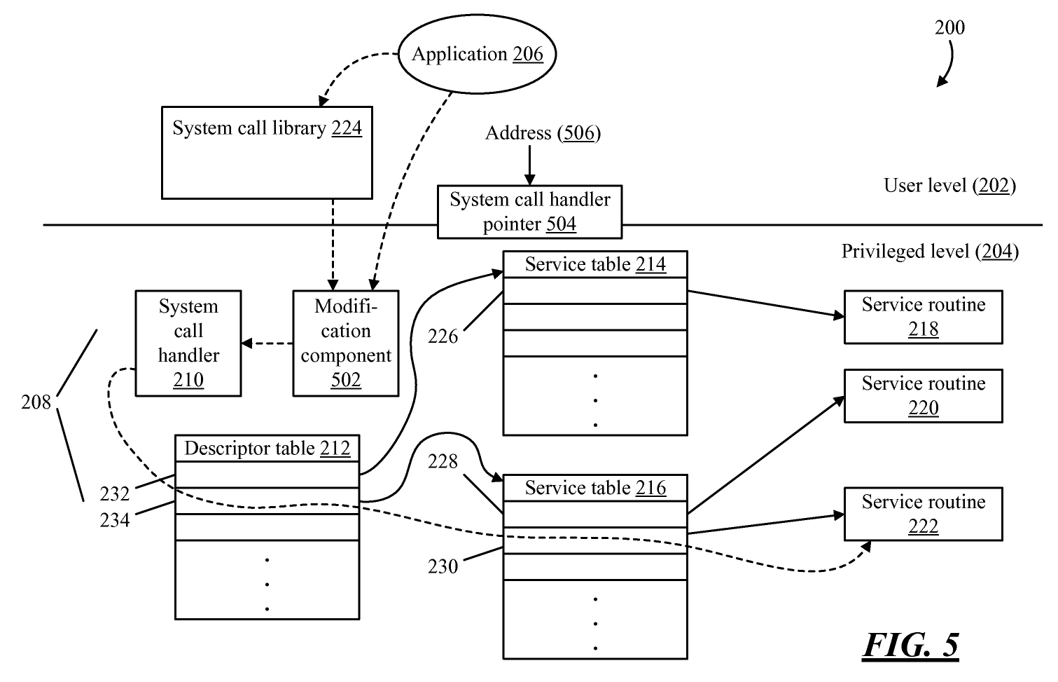

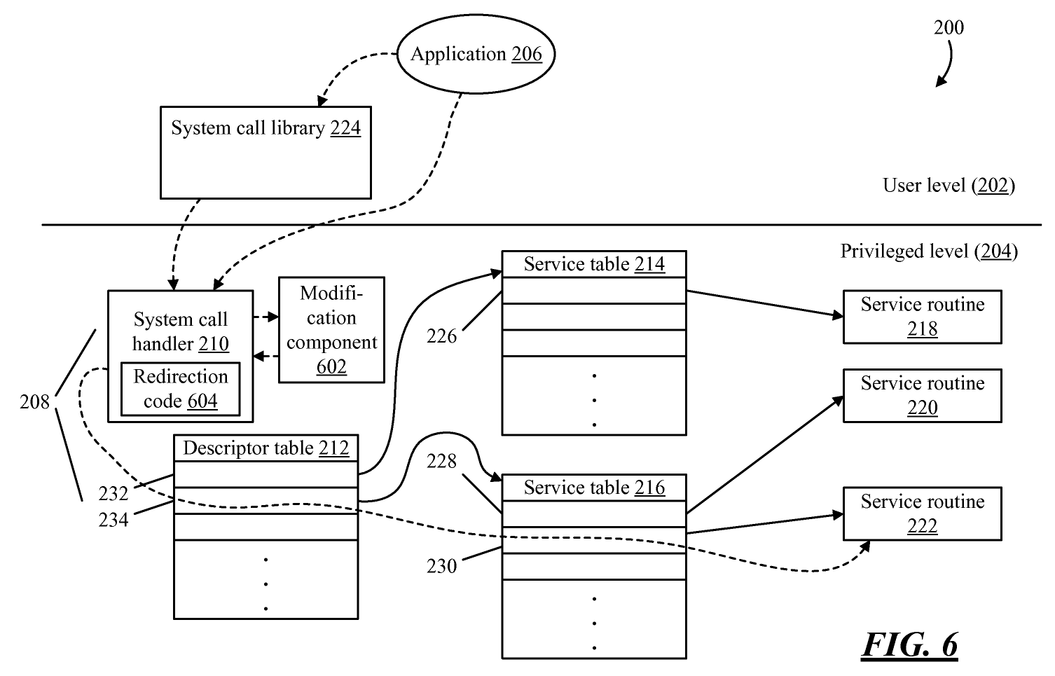

FIGS. 5 and 6 show ways to implement the modification of a system call's behavior, without modifying the service table or the descriptor table.

FIG. 5 shows another example way in which a service modifier could be implemented and/or deployed. In the example of FIG. 5, service modification is performed through modification component 502. System calls made by an application may be directed to modification component 502, where they may be pre-processed before invoking system call handler 210. Modification component 502 may also handle post-processing of results and/or side effects. A system in which modification component 502 is deployed may have a system call handler pointer 504. Such a pointer may be stored in a register, or in some other memory location. When a system call is invoked (e.g., by interrupt, etc.), the system typically looks to system call handler pointer 504 for the location of the executable component to invoke. Normally, system call handler pointer 504 is set to the address of system call handler 210, so that the system call handler would be invoked when a system call is made. However, in order to insert modification component 502 into the process of handling system calls, system call handler pointer 504 may be set to an address 506 of modification component 502. In this way, system calls are directed to modification component 502 instead of system call handler 210. After modification component 502 (optionally) pre-processes the system call, it may invoke system call handler 210 to handle the (possibly modified) system call. The dotted lines in FIG. 5 show example paths that a system call may take.

FIG. 6 shows another example way in which a service modifier could be implemented and/or deployed. In the example of FIG. 6, service modification is performed through modification component 602. Modification component 602 behaves similarly to modification component 502 (shown in FIG. 5), in that it may pre-process and/or post-process system calls. However, in FIG. 6, system calls are initially routed to system call handler 210, which then invokes modification component 602. Modification component 602 then pre-processes a system call and returns control to system call handler 210 to handle the pre-processed system call (which may have been modified by the pre-processing). The system call may then be routed to the appropriate service routine (e.g., service routine 222) through the path shown in the dotted line. System call handler 210 may be modified to include redirection code 604, which causes system call handler 210 to invoke modification component 602 when system call handler 210 receives a system call to process. As in FIGS. 3-4, the dotted lines in FIG. 6 show example paths that a system call may take, and show that a system call may be initiated with or without using system call library 224.

The scenario in FIG. 5 may be simpler to implement than the scenario in FIG. 6, since handling of system calls can be redirected to modification component 502 (shown in FIG. 5) merely by changing the value of the system call handler pointer. However, there may be reasons to minimize detectability of the fact that system call behavior has been changed, and the change of a single value in a known location is easily detectable. Thus, the scenario in FIG. 6 may be less detectable, since the modification of system call handler 210 to include redirection code 604 (as in FIG. 6) may be more difficult to detect than the change of a pointer value (as in FIG. 5).

As noted above, a service modifier may pre-process and/or post-process a system call in order to modify the system call's behavior. Example processes of pre-processing and post-processing, respectively, are shown in FIGS. 7 and 8. Before turning to a description of FIG. 7-8, it is noted that the various flow diagrams in the figures (both in FIGS. 7-8 and elsewhere) show examples in which stages of a process are carried out in a particular order, as indicated by the lines connecting the blocks, but the various stages shown in these diagrams may be performed in any order, or in any combination or sub-combination.

FIG. 7 shows an example process 700 of pre-processing a system call. At 702, the system call may be invoked by an application's calling of a particular library function. The example at 702 shows a function named “_function_name” being called on an argument list 704 that contains one or more arguments (which are shown as “arg1, . . . , argn”). At 706, the library routine that corresponds to the named function is invoked. The library routine forms a system call 712. The particular way in which the system call is formed is implementation dependent (e.g., it may depend on the particular operating system involved, and/or the particular hardware on which the operating system is running.) However, one typical way for the library routine to form the system call is to load, into a specified memory location, the service number 708 (or some other kind of identifier) of the particular OS service that the system call seeks to invoke, the size 710 of the argument list, and the argument list 704 itself. The library routine may then generate an interrupt, which causes the system call handler to read the information in the specified location, whereupon the system call handler may invoke the appropriate service routine that corresponds to service number 708, and pass argument list 704 to that service routine. (Since argument lists to different system calls may be of different sizes, argument list size 710 may serve as a type of delimiter so that the system call handler knows where the argument list ends. However, this particular format is merely an example that may be used in certain implementations. Information relating to a system call could be passed to a system call handler in any format.)

In the foregoing description, a system call 712 is formed through a library routine. However, as previously noted, system calls need not be made through a particular set of library routines, and could be made in any manner. Moreover, as previously described, many of the mechanisms described herein for modifying a system call do no rely on the system call's being made through particular library routines.

System call 712 may be provided to service modifier 120. FIGS. 2-6, as described above, show some example ways in which service modifier 120 could be implemented, although service modifier 120 could be implemented in any manner.

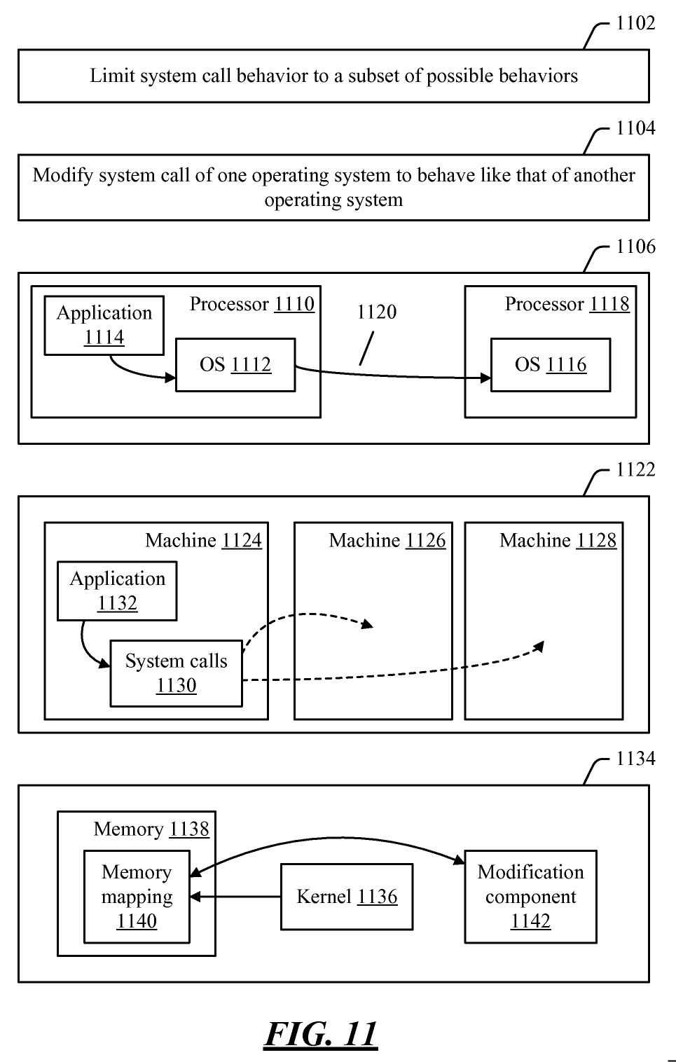

Service modifier 120 may perform a modification 714 to system call 712, and this modification may take various forms. One example modification is to modify the arguments in argument list 704, which are part of system call 712 (block 716). For example, a system call might request to allocate memory for a process, and might specify, as an argument, the number of bytes to be allocated. Service modifier 120 might impose a QoS limit on the amount of memory that can be allocated to a process, and if the amount of memory requested exceeds this limit, service modifier 120 could change the argument to comply with the limit. Another example of a modification that could be performed is to change service number 708, in order to invoke a different service than the one that the calling application requested (block 718). This technique effectively changes one system call into another system call. Yet another example of a modification is to direct the system call to another machine (block 720). (FIG. 11 shows a scenario in which modification of a system call might be used to direct a system call to a different machine than the one on which the system call was initially made.) Yet another example of a modification is to intercept the system call before the system call is passed on to a service routine (block 722). For example, the modification of a system call might involve making a radical departure from the way that the system call would normally be handled by its normal service routine, or might even involve aborting the system call before it is executed. In such a case, service modifier 120 could intercept the system call, and either perform some action in response to the system call (without involving an existing service routine), or might return from the system call without carrying out any of the request contained in the system call. Such interception of a system call is one example of pre-processing of the system call.

Assuming that modification 714 has not resulted in interception of system call 712, a modified system call 724 is generated. Modified system call 724 may comprise a service number 726, an argument list 728, and a size 730 of the argument list. Zero or more of these elements may be modified relative to their values in system call 712.

The modified system call 724 may then be provided to system call handler 210. As described above in connection with FIGS. 2-6, modification of a system call may take place before or after the system call is sent to a system call handler, and thus the depiction in FIG. 7 of modified system call 724's being sent to system call handler 210 is merely an example. In other examples, system call 712 could be sent to a system call handler, whereupon pre-processing of the system call could take place in components that are downstream of system call handler 210 (e.g., as shown in FIGS. 3 and 4).

FIG. 8 shows an example process 800 in which a system call may be post-processed. At 802, the system call executes. Execution of the system call may produce a result 804, and/or a side effect 806. A return value generated by the system call is an example of result 804. Side effect 806 is an effect that is produced by execution of the system call, even if it is not part of the return value of the system call. For example, as previously described, a “write” system call might produce a return a value indicating whether or not the write succeeded (the “result”), and might also generate other effects (e.g., copying data into a write buffer, sending the write buffer to a particular device or file, etc.) that are not part of the return value. These other effects are referred to herein as “side effects.”

Service modifier 120 may post-process a system call in the sense that it may modify side effect 806 and/or result 804. Thus, service modifier 120 may produce a modified result 808. For example, if a service routine generates a return value, and if service modifier 120 changes the generated return value into a new return value, then the new return value is a modified result 808. Service modifier 120 may also modify side effect 806. For example, if execution of a system call has written some data into a memory location, service modifier 120 may modify this side effect by changing the data in some manner—e.g., by overwriting the data, by adding to the data, etc. In general, if side effect 806 puts a machine, or a component of a machine in a particular state, post-processing may involve changing of that state.

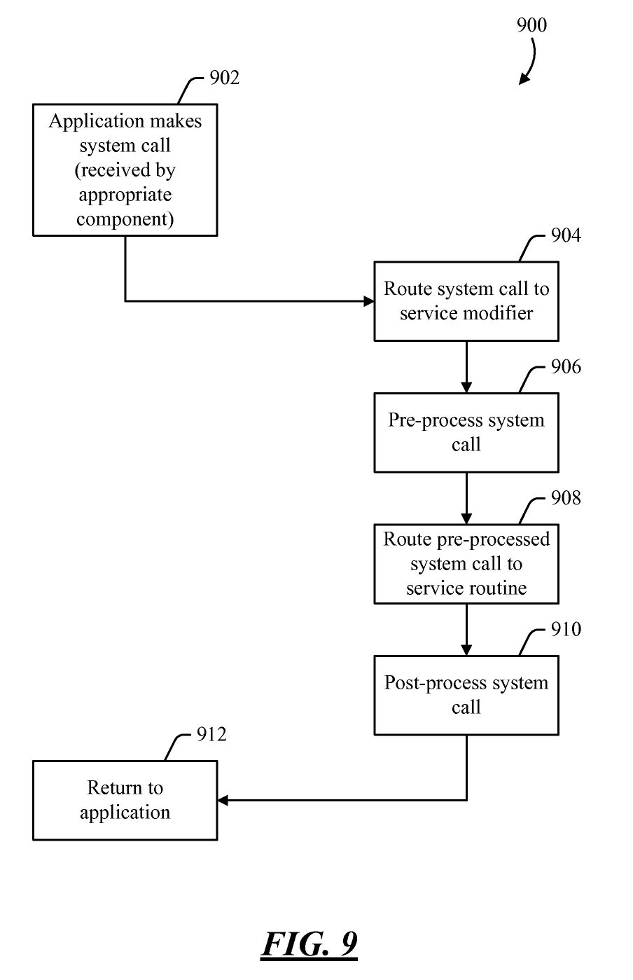

FIG. 9 shows, in the form of a flow chart, an example process 900 in which an application makes a system call that is routed to a service modifier. At 902, an application makes a system call (which may be received by an appropriate component, examples of which are shown in FIGS. 2-6). At 904, the system call may be routed to a service modifier. The various modification components shown in FIGS. 2-6 are examples of service modifiers. At 906, the system call may be pre-processed. Examples of pre-processing are discussed above in connection with FIG. 7. At 908, the pre-processed system call may be routed to a service routine. As discussed above, some pre-processed system calls are intercepted rather than being routed to service routines. However, if a system call is not intercepted at the pre-processing stage, then it may be routed to a service routine at 908. At 910, the system call may be post-processed. Examples of post-processing are discussed above in connection with FIG. 8. The system call may be post-processed regardless of whether it is carried out by a service routine or has been intercepted. (Intercepted system calls may still produce results and/or side effects, since the service modifier itself may carry out a procedure in response to a system call, even if the system call is not passed to the normal service routine. In such a case, whatever results and/or side effects are produced by the service modifier may be pre-processed). At 912, flow control may return to the application that made the system call.

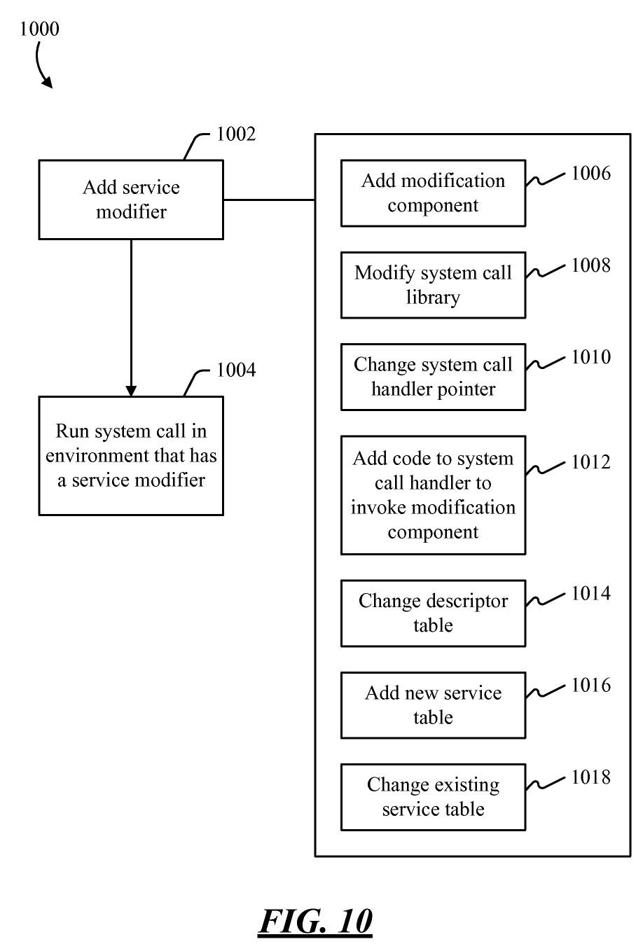

FIG. 10 shows, in the form of a flow chart, an example process 1000 in which one or more components to modify the behavior of a system call may be added to a computing environment, and then used to execute the system call. At 1002, a service modifier may be added to a computing environment that provides system call. For example, a service modifier may be added to an environment for use with the kernel of an operating system, or for use with a system call library, as variously shown in FIGS. 2-6 and described above. At 1004, a system call may be run in an environment that has a service modifier.

As previously described, a service modifier may be implemented in various ways. FIG. 10 shows various stages that may be performed to add a service modifier to an environment. One or more of these stages (or other stages) may be performed to add a service modifier to an environment.

A modification component may be added to the environment in which system calls are processed (block 1006). Modification components 254, 302, 404, 502, and 602 (shown variously in FIGS. 2-6) are examples of modification components that may be added at block 1006.

In order to allow system calls to be routed through a modification component, various other changes may be made to the environment. For example, a system call library may be modified (block 1008). FIG. 2, described above, shows an example in which a system call library has been modified to route system calls through a modification component. Other examples of modifications include changing a system call handler pointer (block 1010), adding code to a system call handler to invoke a modification component (block 1012), changing a descriptor table (block 1014), adding a new service table (block 1016), and changing an existing service table (block 1018). Examples of systems that may be created using some combination of blocks 1006-1018 are variously shown in FIGS. 2-6.

Modification of system call behavior may be used in various ways. FIG. 11 shows some example ways in which modification of system calls may be used.

One way in which modification of system call behavior may be used is to limit the behavior of a given system call to some subset of possible behaviors (block 1102). As described above, there may be a QoS constraint that governs the service that a system call may provide to a program. For example, a memory-allocation system call might allow a process to request arbitrary amounts of memory, but a QoS constraint might specify that a process may receive only 10 Mb of memory. Thus, if the amount of memory requested is an argument to the system call, a modification component might examine and modify the argument specified by an application to ensure that the argument does not result in allocation of more memory than the QoS constraint allows. If an application issues, e.g., a request for 20 Mb of memory by specifying the number of bytes in an argument, the modification component might modify the argument to a lower number in order to cause the system call, when invoked, to comply with a per-process memory-allocation limit. The modification component might also maintain a running total of the amount of memory that has been allocated to a process, in order to enforce this constraint across different instances of the system call (e.g., a request for 2 Mb may be converted to a request for 1 Mb, if prior system calls have already obtained allocation of 9 Mb). Other types of QoS constraints could be implemented—e.g., the amount of data that a process may write per unit of time, the number of new processes that a given process may spawn, etc.

Another example of how a service modifier could modify the behavior of a system call is to cause a system call in one OS to behave like a system call in another OS (block 1104). This example may provide a way for one operating system to execute software built for another operating system. For example, by modifying the behavior of system calls in the MICROSOFT WINDOWS operating system to behave like Linux system calls, it may be possible for an application built for Linux to execute on the MICROSOFT WINDOWS operating system. The same principles can be applied in the opposite direction, allowing MICROSOFT WINDOWS applications to run on a modified Linux kernel.

Another way in which a service modifier could modify the behavior of a system call is to route the system call from one processor to another (block 1106). The scenario shown in block 1106 may occur, for example, when a limited-purpose processor is used. Suppose that processor 1110 is a limited-purposed processor, such as a graphics accelerator. Processor 1110 may have an operating system 1112. Application 1114 may make a system call to operating system 1112. If processor 1110 is a limited-purpose processor, it may have the ability to perform certain functions (e.g., graphics output), but not others (e.g., writing to a file on disk). In operating system 1112's default behavior, a system call that attempts to write to a file might be rejected on the ground that such a system call requests a service that processor 1110 cannot fulfill. However, the behavior of this system call could be modified to route such requests to operating system 1116, which executes on processor 1118. In this example, processor 1118 is a general-purpose processor which controls the typical hardware associated with a computer (e.g., disk drives, etc.). Thus, the system calls on operating system 1112 could have their behavior modified such that, if operating system 1112 receives a request to write to a disk (or to perform some other operation that is normally performed on the general-purpose processor), the system call could be re-routed to operating system 1116 (as indicated by arrow 1120).

Another way in which service modifier could modify the behavior of a system call is to implement support for distributed processing (block 1122). Normally, a system call is handled on the machine to which the system call is made. A machine, however, may be part of a distributed computing arrangement. System call behavior could be modified so that a system call received at one machine could be routed to one or more other machines. For example, block 1122 shows a distributed arrangement with machines 1124, 1126, and 1128. There may be system calls 1130 implemented on machine 1124, and an application 1132 that runs on machine 1124 might issue a system call on that machine. System calls 1130, however, may have been modified to route the system call to machines 1126 or machine 1128. The decision to route the system call to another machine could be based on availability (e.g., the system call could be routed to other machines for load balancing among the machines), or based on division of functionality among machines (e.g., one machine could be designated to handle a particular system call, or a particular category of system calls). Application 1132 might issue the system call on machine 1124 just as if the system call were to be executed on machine 1124. Thus, modification of system calls 1130 allows these system calls to re-route system calls to other machines in a way that does not involve application 1132 in the details of the rerouting. In this way, modification of system call behavior may be used to support a distributed computing arrangement.

Yet another example way in which modification of system call behavior could be used is to extend the functionality of system calls by providing memory layout information (block 1134) or data flow usage information. Normally, a process accesses a machine's physical memory through the abstraction of virtual addresses. The operating system assigns the mapping of virtual-to-physical addresses, and does not share this information with the processes. However, system calls could be augmented to provide this information to processes. Thus, the example of block 1134, kernel 1136 manages a memory 1138. In the course of managing memory 1138, kernel 1136 assigns a particular memory mapping 1140 for use by a particular process. Modification component 1142 may access this memory mapping. Thus, for example, when a process uses system calls to read memory, write memory, allocate new memory, etc., these operations may change mapping 1140. Modification component 1142 may modify the behavior of these system calls so that the system calls will report on the state of mapping 1140, and/or changes to mapping 1140. E.g., if a “read” system call requests to read memory that has been paged to disk, the system call may result in moving one or more virtual pages from disk to memory; a modified system call could report on the physical memory location in which the virtual page is being stored following the “read” system call. In greater generality, kernel 1136 may maintain internal data structures, and may make changes to those internal data structures. Modification component 1142 may learn of changes to the internal data structures, and may modify the behavior of a system call to report these changes to an application (even if the normal behavior of the system call is not to report these changes). The data structures may be “internal” in the sense that they are maintained by the kernel are are not normally accessible outside of the kernel. Mapping 1140 is an example of these internal structures, although kernel 1136 may maintain other internal data structures.

One example of how this information about mapping 1140 could be used is to implement a security application. A security application might be designed to detect and/or prevent the use of malware by tracking the movement of data. Such an application might attempt to enforce a rule that protected data stay in locations that are controlled by trusted applications, and might conclude that a security violation has occurred if protected data moves into a space controlled by an untrusted program. Detecting such movement may involve knowing the physical memory locations in which protected data has been placed. By tracking the physical movement of data, it is possible to determine whether a location that stores protected data has come under control of a non-trusted application. While system calls do not normally report to an application how the kernel has laid out the use of physical memory for the process in which the application executes, system calls (such as those that affect the contents of memory) could be modified to report this information.

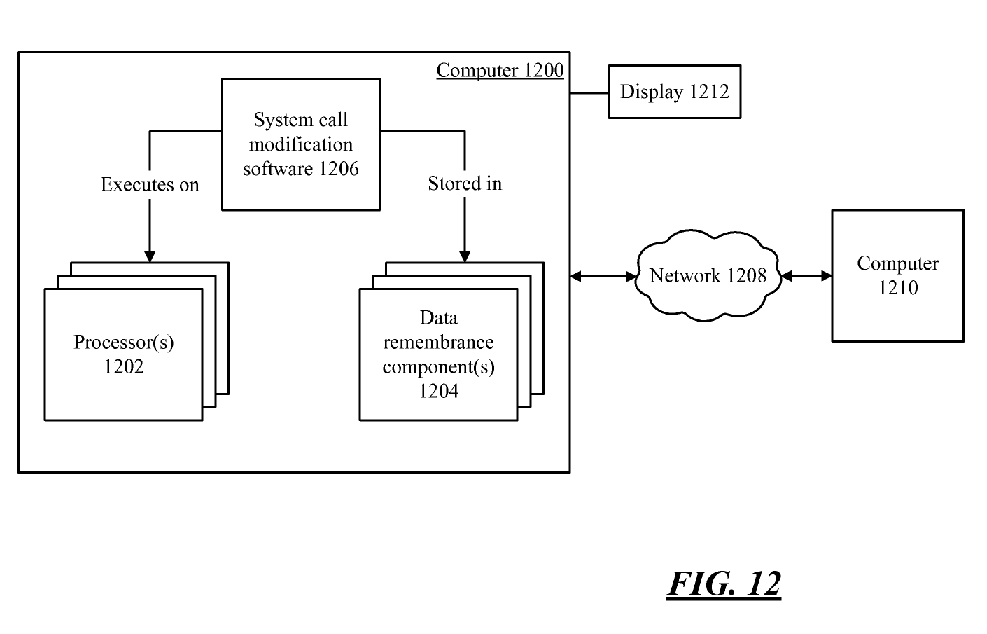

FIG. 12 shows an example environment in which aspects of the subject matter described herein may be deployed.

Computer 1200 includes one or more processors 1202 and one or more data remembrance components 1204. Processor(s) 1202 are typically microprocessors, such as those found in a personal desktop or laptop computer, a server, a handheld computer, or another kind of computing device. Data remembrance component(s) 1204 are components that are capable of storing data for either the short or long term. Examples of data remembrance component(s) 1204 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 1200 may comprise, or be associated with, display 1212, which may be a cathode ray tube (CRT) monitor, a liquid crystal display (LCD) monitor, or any other type of monitor.

Software may be stored in the data remembrance component(s) 1204, and may execute on the one or more processor(s) 1202. An example of such software is system call modification software 1206, which may implement some or all of the functionality described above in connection with FIGS. 1-11, although any type of software could be used. Software 1206 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 12, although the subject matter described herein is not limited to this example.

The subject matter described herein can be implemented as software that is stored in one or more of the data remembrance component(s) 1204 and that executes on one or more of the processor(s) 1202. As another example, the subject matter can be implemented as software having instructions to cause a computer to perform one or more acts of a method, where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium.

In one example environment, computer 1200 may be communicatively connected to one or more other devices through network 1208. Computer 1210, which may be similar in structure to computer 1200, is an example of a device that can be connected to computer 1200, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions that, when executed by a computer, cause the computer to perform a method of handling a system call, the method comprising:
receiving a system call from a program;
routing said system call to a service modifier;
pre-processing said system call by said service modifier to generate a modified system call;
routing said modified system call to a service routine that acts on said modified system call; and
returning to said program.

2. The one or more computer-readable storage media of claim 1, wherein said system call comprises an argument, and wherein said pre-processing comprises:
modifying said argument, said modified system call having said modified argument in place of said argument.

3. The one or more computer-readable storage media of claim 1, wherein said system call comprises a first identifier of a first service to be invoked, and wherein said pre-processing comprises:
replacing said first identifier with a second identifier that identifies a second service that is different from said first service.

4. The one or more computer-readable storage media of claim 1, wherein said system call comprises an argument, and wherein said pre-processing comprises:
modifying said argument to cause said service routine, when invoked on said modified system call, to comply with a constraint governing service to be provided to said program.

5. The one or more computer-readable storage media of claim 1, wherein said system call is made to a first operating system and wherein said pre-processing comprises:
modifying said system call to cause said service routine to respond to said modified system call as if said system call had been made to a second operating system that is different from said first operating system.

6. The one or more computer-readable storage media of claim 1, wherein the method further comprises:
post-processing said system call after said service routine acts on said system call.

7. The one or more computer-readable storage media of claim 6, wherein said post-processing comprises:
modifying a result returned by said service routine; or
modifying a side effect of said service routine.

8. A system comprising:
a first component of an operating system, said first component performing a service;
a system call handler that receives a system call from a program and invokes said first component to perform said service; and
a service modifier that modifies said system call to produce a modified system call, said first component being invoked on said modified system call.

9. The system of claim 8, wherein said program makes said system call through a library, wherein said service modifier comprises:
a modification component that modifies said system call to produce said modified system call; and
detour code in said library, which causes system calls made through said library to be routed to said modification component.

10. The system of claim 8, wherein said first component implements a routine that performs said service, wherein said system call handler uses a service table to identify said first component as being where to route said system call, and wherein said service modifier comprises:
a modification component that modifies said system call to produce said modified system call, there being an entry in said service table that points to said modification component.

11. The system of claim 8, wherein said first component implements a routine that performs said service, wherein said operating system comprises a plurality of tables, wherein said system call handler uses a descriptor table to identify which of said plurality of tables identifies a component that is to handle said system call, and wherein said service modifier comprises:
a first service table that is not native to said operating system;
an entry in said descriptor table that points to said first service table; and
a modification component, pointed to by said first service table, that modifies said system call to produce said modified system call.

12. The system of claim 8, wherein said service modifier comprises:
a modification component that modifies said system call to produce said modified system call; and
a pointer that the system uses to identify a component to be invoked to handle a system call, said pointer being set to an address that identifies said modification component such that said modification is invoked to handle system calls in place of said system call handler, said modification component invoking said system call handler on said modified system call.

13. The system of claim 8, wherein said service modifier:
a modification component that modifies said system call to produce said modified system call; and
redirection code, in said system call handler, that causes said modification component to be invoked on said system call when said system call is received by said system call handler, said system call handler receiving said modified system call from said modification component.

14. The system of claim 8, wherein said system call comprises a first argument list, and wherein said service modifier modifies said system call by changing said first argument list to a second argument list.

15. A method of informing an application about a memory mapping assigned by an operating system, the method comprising:
adding, to an environment provided by the operating system, a modification component that modifies system calls to produce modified system calls, said operating system providing a system call that affects a location of data in a memory, said modification component obtaining information about a mapping of said memory, said information not being provided by said system call; and
running the application in an environment that includes said modification component, said application receiving, from said modification component in response to said application's having issued said system call, said information about said mapping of said memory.

16. The method of claim 15, wherein said application issues said system call through a library of functions, and wherein the method further comprises:
modifying said library of functions to invoke said modification component when said application issues said system call.

17. The method of claim 15, wherein said operating system comprises a system call handler that uses a service table to route said system call to a service routine that responds to said system call, and wherein the method further comprises:
modifying said service table to point to said modification component, wherein said modification component invokes said service routine after modifying said system call.

18. The method of claim 15, wherein said operating system comprises a system call handler that uses a service table to route said system call, wherein said system call handler uses a descriptor table to identify which service table to use to route said system call, and wherein the method further comprises:
adding a new service table to a set of existing service tables; and
changing said descriptor table to point to said new service table.

19. The method of claim 15, wherein said operating system comprises a system call handler, wherein a machine on which said operating system runs comprises a pointer that identifies a component to be invoked in response to a system call, and wherein the method further comprises:
changing said pointer to point to said modification component instead of said system call handler.

20. The method of claim 15, wherein said application uses said information about said mapping of said memory to track whether data is moving into a location in which it can be controlled by an untrusted application.
